(19) United States
(12) Patent Application Publication
(10) Pub. No.: US 2024/0195271 A1
(43) Pub. Date: Jun. 13, 2024

(54) WINDING SEPARATION METHOD

(71) Applicant: HONDA MOTOR CO., LTD., Tokyo (JP)

(72) Inventors: Keiya Nimura, Wako-shi (JP); Shogo Miyazaki, Wako-shi (JP)

(21) Appl. No.: 18/487,786

(22) Filed: Oct. 16, 2023

(30) Foreign Application Priority Data
Dec. 8, 2022 (JP) 2022-196480

(51) Int. Cl. H02K 15/00; B23P 19/04

(52) U.S. Cl. CPC H02K 15/0006; B23P 19/04

(57) ABSTRACT

A winding separation method of separating a winding from an electric motor stator that includes a stator core and a coil attached to the stator core and has insulating paper between the winding of the coil and the stator core, which the winding is covered with a coating having insulating properties, which method includes: a heating step of heating the electric motor stator; a cutting step of cutting a predetermined welded portion of the electric motor stator and a portion of the winding; and an extraction step of extracting the winding from the stator core, in which a heat-resistant temperature of the insulating paper is lower than a glass transition temperature of the coating of the winding.

### INCORPORATION BY REFERENCE

The present application claims priority under 35 U.S.C. § 119 to Japanese Patent Application No. 2022-196480 filed on Dec. 8, 2022. The content of the application is incorporated herein by reference in its entirety.

### BACKGROUND OF THE INVENTION

### Field of the Invention

The present invention relates to a winding separation method.

### Description of the Related Art

A winding coil separation method has been disclosed in which: an electric motor stator for a home appliance such as a refrigerator, an air conditioner, or a washing machine has a stator core; the stator core has a winding coil having a crossover portion protruding near one end face of the stator core, the crossover portion being cut off; and the winding coil with one end cut off is relatively extracted in the axial direction toward the other end face of the stator core (see, for example, Japanese Patent No. 4079758).

An electric motor stator employed for a vehicle generally has a complicated structure and also has a winding or the like strongly bonded due to use in severe environments in terms of temperature, vibration, or the like, compared to an electric motor stator for a home appliance. Therefore, it has been difficult to separate the winding from the electric motor stator employed for a vehicle by conventional separation methods.

For example, an electric motor stator or the like employed for a vehicle employs a structure in which varnish is permeated into gaps in slots and insulating paper and a coil (winding) are strongly fixed to a stator core by the varnish. The varnish impregnation rate greatly varies due to narrow space inside each slot, and the varnish is generally impregnated to the extent that the varnish overflows the slot. Great variation in the varnish impregnation rate increases variation in the winding adhesive force (also called adhesive strength or fixing strength). This increased variation in the adhesive force may require time to separate the winding, or may cause a strong adhesive force making it impossible to separate the winding.

In addition, the electric motor stator employed for a vehicle often has a great occupancy ratio in the slots (ratio of the winding included in the slots), and is generally dismantled by a crushing method. In the case of the crushing method, the copper material and the iron-based material included in each winding are mixed together, and the materials will be recycled as low-grade materials.

The present invention has been made in view of the circumstances described above, and it is an object of the present invention to provide a winding separation method that can be applied to an electric motor stator employed for a vehicle, allows applying heating using energization of a winding, and is suitable for recycling the winding.

### SUMMARY OF THE INVENTION

There is provided a winding separation method of separating a winding from an electric motor stator having insulating paper between a stator core and the winding, the winding being covered with a coating having insulating properties, the winding separation method including: a heating step of heating the electric motor stator; a cutting step of cutting a predetermined welded portion of the electric motor stator and a portion of the winding; and an extraction step of extracting the winding from the stator core, in which a heat-resistant temperature of the insulating paper is lower than a glass transition temperature of the coating.

It is possible to provide a winding separation method that can be applied to an electric motor stator employed for a vehicle, allows applying heating using energization of a winding, and is suitable for recycling the winding.

### BRIEF DESCRIPTION OF THE DRAWINGS

FIG. 1 is a diagram showing an electric motor stator to which a winding separation method according to an embodiment of the invention is applied;

FIG. 2 is a diagram schematically showing a cross-sectional structure of insulating paper together with a stator core and a winding;

FIG. 3 is a diagram showing a crushing method;

FIG. 4 is a diagram showing an extraction method; and

FIG. 5 is a diagram showing an example of a jig used in an extraction step.

### DETAILED DESCRIPTION OF THE PREFERRED EMBODIMENT

An embodiment of the present invention will be described below with reference to the drawings.

### EMBODIMENT

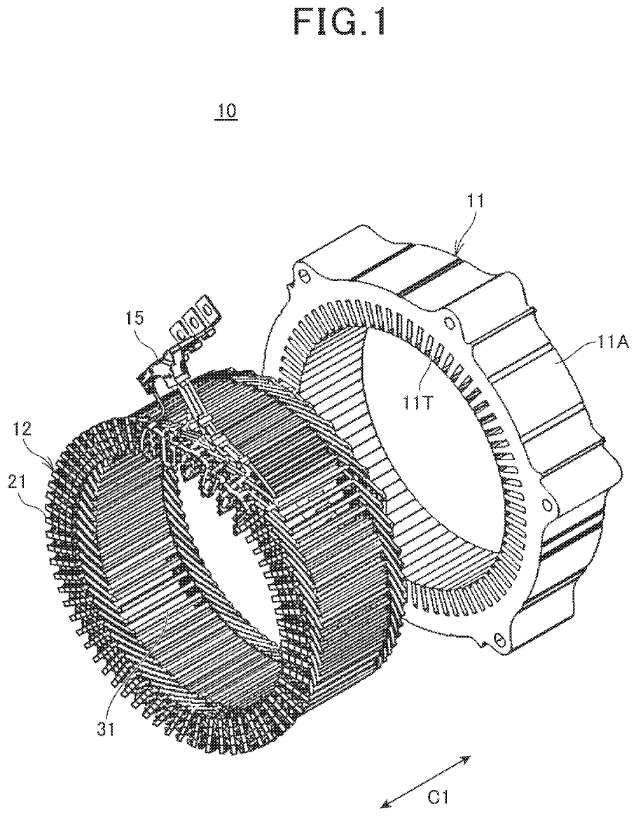

FIG. 1 is a diagram showing an electric motor stator to which a winding separation method according to the embodiment of the present invention is applied.

This electric motor stator 10 is a component that generates a rotating magnetic field, and is a stator used for an electric motor mounted on a vehicle. However, the electric motor stator 10 does not have to be limited to use for vehicles. The electric motor stator 10 is hereinafter referred to as “stator 10”.

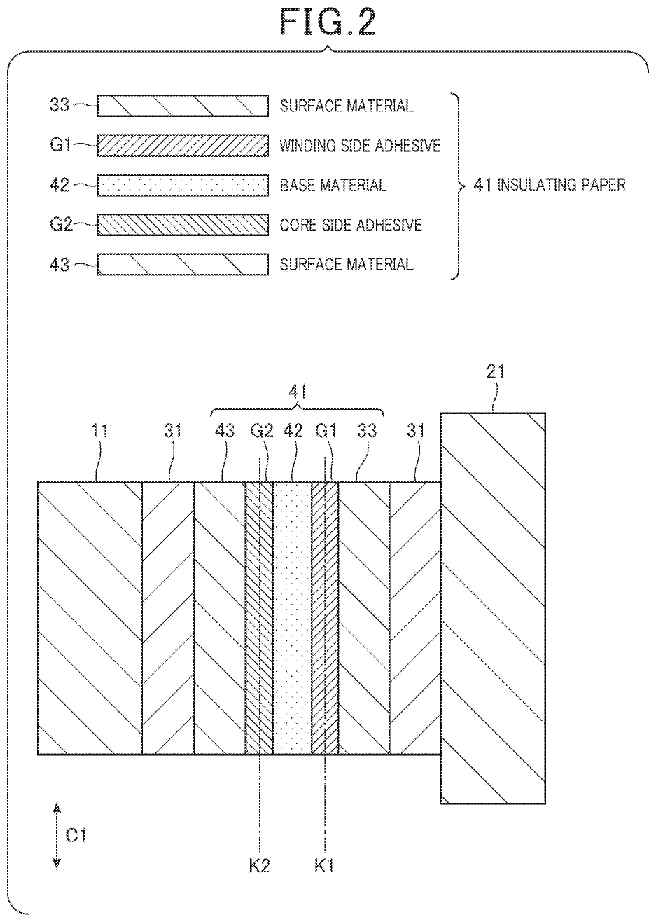

The stator 10 includes a stator core 11 in a tubular shape and a coil 12 attached to the stator core 11. The stator core 11 is provided with teeth 11T protruding to the inner circumferential side at intervals in the circumferential direction. A winding 21 is arranged in slots formed between the adjacent teeth 11T via insulating paper 41, and the slots are then impregnated with varnish 31 (FIG. 2), whereby the insulating paper 41 and the winding 21 are fixed to the stator core 11.

A reference character C1 in FIG. 1 indicates the axial direction of the stator 10, and the direction coincides with the axial direction of the electric motor. The winding 21 has a power distribution component 15 at the end portion thereof.

The coil 12 generally corresponds to the winding 21. In this description, when the coil 12 is separated after being assembled with the stator core 11, at least a portion of the insulating paper 41 adheres on the side of the coil 12. Therefore, the insulating paper 41 may also be described as a member on the side of the coil 12.

The stator core 11 is formed by laminating electromagnetic steel plates in the axial direction C1. The stator core 11 includes a yoke 11A forming an outer circumferential portion of the cylinder, and the teeth 11T protruding from the yoke 11A to the inner circumferential side.

The winding 21 is bundled into a predetermined shape and arranged in each slot formed between the teeth 11T. The winding 21 of this configuration is a so-called SC winding (segment conductor coil) in which U-shaped segment conductors are inserted into the slots so that each of the slots has the open side of the segment on one side and has the close side of the segment on the other side. Note that the winding 21 is not limited to the SC winding.

The winding 21 is a wire material in which a periphery of a metallic conductor such as steel wire, copper wire, or aluminum wire is covered with a coating having insulating properties (hereinafter referred to as an insulating coating). The insulating coating is, for example, an enamel coating.

Components of an enamel coating include, for example, polyurethane resin, polyester resin, polyamideimide, or the like.

The varnish 31 is a thermosetting resin with insulating properties, has adhesive properties to the winding 21 or the like, and functions as a protective film and fixing material for the winding 21. More specifically, varnish impregnation processing, in which the varnish 31 permeates into the gaps in the slots, causes the varnish 31 to bond the winding 21 or the like and solidifies. This enhances the insulating function of the coil 12, improves mechanical strength, prevents moisture, dust, or the like from entering inside the winding 21, and improves also heat dissipation. A wide range of known varnishes can be applied to the varnish 31.

The insulating paper 41 is a sheet material having insulating properties, and is also called an insulating sheet. Arranging the insulating paper 41 between the winding 21 and the stator core 11 enhances the insulating function between the winding 21 and the stator core 11.

FIG. 2 is a diagram schematically showing the cross-sectional structure of the insulating paper 41 together with the stator core 11 and the winding 21.

As shown in FIG. 2, the insulating paper 41 has a multi-layer structure consisting of a base material 42 and surface materials 33 and 43 bonded to the respective sides of the base material 42 with adhesives G1 and G2. The multi-layer structure facilitates obtaining the performance desired for the insulating paper 41, that is, facilitates improving insulating properties, heat-resisting properties, mechanical strength, or the like. For example, the base material 42 employs a polyamide epoxy alloy sheet material having high insulating properties and high heat-resisting properties, and the surface materials 33 and 43 employ aramid paper having high strength and high heat-resisting properties. In addition, the multi-layer structure allows providing an adhesive layer made of the adhesives G1 and G2 in the insulating paper 41.

In this description, when the adhesives G1 and G2 are separately described, the adhesive G1 located closer to the winding 21 than the base material 42 is referred to as “winding side adhesive G1” and the adhesive G2 located closer to the stator core 11 than the base material 42 is referred to as “core side adhesive G2”.

As shown in FIG. 2, there is the varnish 31 between the surface of stator core 11 and the insulating paper 41 and between the surface of the winding 21 and the insulating paper 41.

Generally, the heat-resistant temperature of conventional insulating paper is higher than the glass transition temperature of the insulating coating of the winding 21. Contrarily, in this configuration, adjustment (selection, adjustment in components, or the like) of the adhesives G1 and G2 lowers the heat-resistant temperature of the insulating paper 41, thereby satisfying the following condition (A).

Heat-resistant temperature of insulating paper 41<Glass transition temperature of insulating coating Condition (A)

In this configuration, the heat-resistant temperature of the insulating paper 41 is set lower than a predetermined high temperature T1 (hereinafter referred to as “high temperature T1”). The high temperature T1 is a temperature lower than the glass transition temperature of the insulating coating.

Furthermore, the adhesives G1 and G2 satisfy the following conditions (1) and (2).

Adhesive forces at normal temperature TO: Adhesives G1, G2≤Varnish 31 Condition (1)

Adhesive forces in extraction at temperature TX: Adhesives G1, G2<Varnish 31 Condition (2)

The normal temperature TO is room temperature or the temperature before heating in a heating step described later. The normal temperature TO is also the temperature within the temperature range when the electric motor stator 10 is in use, and can be said to be the temperature when the electric motor is in use.

The temperature TX in extraction is the temperature in an extraction step after heating in the heating step. The high temperature T1 is a temperature that reduces the adhesive forces of the adhesives G1 and G2 to less than the adhesive force of the varnish 31.

When the adhesives G1 and G2 are once heated to the high temperature T1 and then have a temperature drop to the normal temperature TO, the adhesive forces of the adhesives return to substantially the same as the original adhesive forces or do not return to the original adhesive forces, so that the adhesive forces are maintained in a following state: adhesives G1, G2<varnish 31. The temperature TX in extraction just needs to be the high temperature T1 or an appropriate temperature after the high temperature T1 (for example, a normal temperature TO such as the room temperature). Even if the varnish 31 is once heated to the high temperature T1, the adhesive force returns to substantially the same as the original adhesive force when the temperature drops to the normal temperature TO. The high temperature T1 corresponds to a “first temperature” of the present invention, and the normal temperature TO corresponds to a “second temperature” of the present invention.

In other words, in this configuration, the strength of the adhesives G1 and G2 is reduced to the extent that the winding 21 can be easily separated at the positions of the adhesives G1 and G2 at the high temperature T1 that is lower than the glass transition temperature of the insulating coating of the winding 21. Since the insulating coating of the winding 21 is maintained after undergoing the high temperature T1, the winding 21 can be maintained in an insulated state.

Note that the adhesives G1 and G2 generally have temperature change characteristics such that the adhesive forces decrease in high temperatures. In this configuration, if the temperature is equal to or higher than T1, the adhesive force of each of the adhesives G1 and G2 drops to the extent that the winding 21 can be separated from the stator core 11.

When this type of stator is recycled, the stator needs to be dismantled, and dismantling by a crushing method is conventionally common.

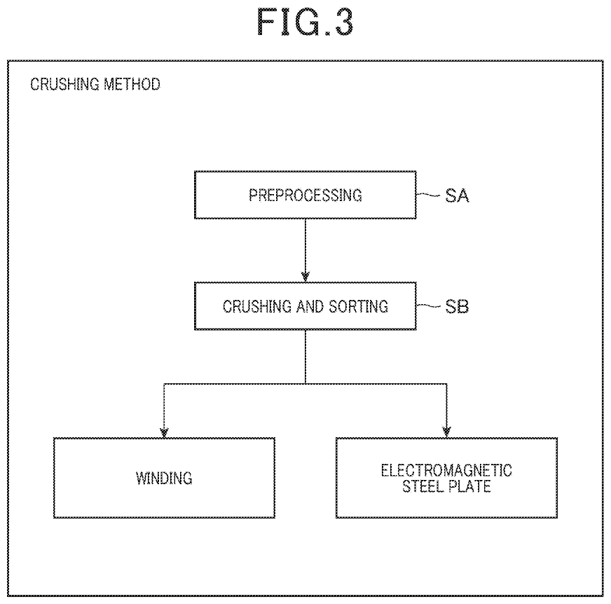

FIG. 3 is a diagram showing a crushing method.

The preprocessing shown in step SA is a step performed before crushing, and removes members that can be removed without crushing. In the crushing and sorting shown in step SB, the stator to be crushed is crushed with a predetermined crusher, and then crushed pieces of the winding and crushed pieces of the stator core (electromagnetic steel plate) are sorted out with a predetermined sorter.

However, even if sorting is performed, the broken pieces of the winding have a large content of impurities that are different from the metal of the winding, and will be recycled as low-grade materials. In addition, the crushed pieces of the electromagnetic steel plate also contain a material different from that of the electromagnetic steel plate. At present, it is generally difficult to recycle electromagnetic steel plates.

Separation by a method other than the crushing method causes the conventional stator to have variation in adhesive force of the winding with the varnish. This variation may require time to separate the winding or may cause a strong adhesive force making it impossible to separate the winding. In particular, since stators for vehicle electric motors are used in severe environments in terms of temperature, vibration, or the like, the stators each have a complicated structure and a winding or the like strongly bonded. Therefore, it has been difficult to separate the stators by a method other than the crushing method.

Contrarily, in this configuration, the heat-resistant temperature of the insulating paper 41 is lower than the glass transition temperature of the insulating coating of the winding 21 as described in the above condition (A). Therefore, the stator 10 is heated to the predetermined high temperature T1 which is equal to or higher than the heat-resistant temperature of the insulating paper 41 and lower than the glass transition temperature of the insulating coating, so that the winding 21 is separated at the position of the insulating paper 41 more easily.

A specific winding separation method will be described.

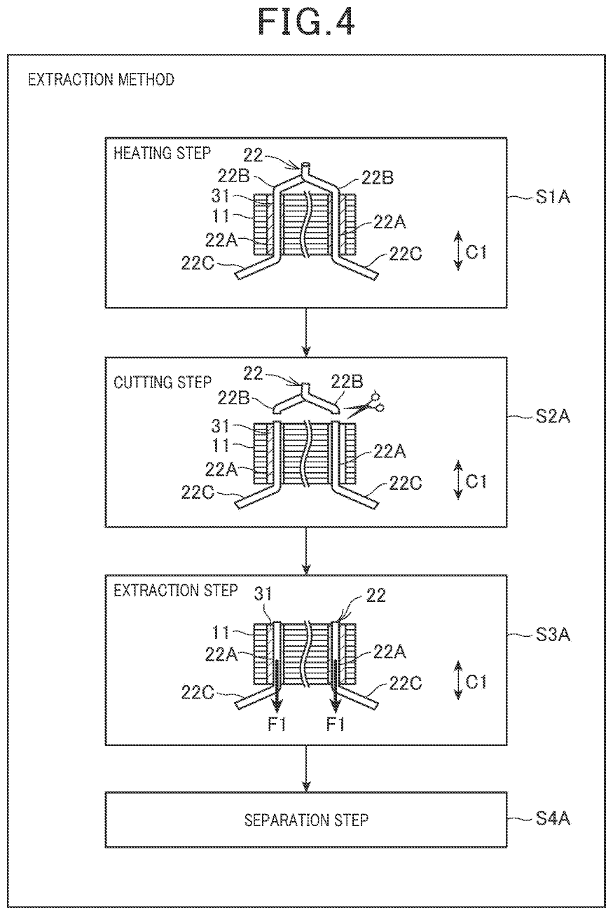

FIG. 4 is a diagram showing an extraction method for separating the winding 21 from the stator 10.

First, in the heating step of step S1A, the stator 10 is heated to a predetermined set temperature T2. The set temperature T2 is a temperature to which the stator 10 is heated that is equal to or higher than the high temperature T1, and is a temperature lower than the glass transition temperature of the insulating coating of the winding 21.

For example, the high temperature T1 just needs to be set to an appropriate temperature within a temperature range equal to or higher than the heat-resistant temperature of the insulating paper 41 and lower than the glass transition temperature of the insulating coating of the winding 21. Note that the heating step can also be referred to as a burning step, a heating step, a heat treatment step, or the like.

In this heating step, the winding 21 is heated using the heat generated by the ohmic loss of the winding 21 by an electric heating method in which a current from an external power supply is passed through the winding 21. This can allow expecting effects of reducing the required thermal energy and reducing the generation of carbon dioxide compared with the method of heating with a furnace such as an industrial furnace. Further, the electric heating method causes the winding 21 itself to generate heat, allowing the temperature of the insulating paper 41 around the winding 21 to be effectively raised.

This heating step causes the winding 21 to have a temperature lower than the glass transition temperature of the insulating coating, allowing the winding 21 to maintain the insulating properties and allowing the winding 21 to be properly prevented from a short circuit or the like. The heating step does not have to be limited to the electric heating method, and may be, for example, heating using a furnace.

Here, a reference numeral 22 in FIG. 4 denotes a U-shaped conductor (corresponding to a segment conductor coil) that forms the winding 21. A U-shaped conductor 22 is inserted inside the insulating paper 41 arranged in the slot and connected by welding or the like to a U-shaped conductor 22 inserted in the adjacent slot.

Each U-shaped conductor 22 has a pair of arm portions 22A, a bent portion 22B, and a pair of distal end portions 22C. The arm portions 22A extend linearly in the same direction on the left and right sides of the U shape. The bent portion 22B is formed by bending the proximal end portions of the arm portions 22A and coupling them with each other. The distal end portions 22C are the distal end portions of the arm portions 22A respectively coupled with the adjacent arm portions 22A. The bent portions 22B are located on one side in the axial direction with respect to the stator core 11.

The cutting step of step S2A is a step performed before the extraction step of step S3A, and removes parts that hinder the extraction in the extraction step. In this case, the cutting step cuts at least: each welded portion corresponding to a position connecting the end portions of a conductor 22 and another conductor 22; and each bent portion 22B being a portion of the winding 21. In other words, the cutting step cuts the portions that hinder the extraction of the winding 21 to the other side in the axial direction with respect to the stator core 11. Note that it is possible to appropriately employ the cutting position at any position at which the region that hinders the extraction can be cut off.

In the extraction step of step S3A, a load F1 is applied to the stator 10 to extract the winding 21 from the stator core 11 in the axial direction C1 (to the other side in the axial direction).

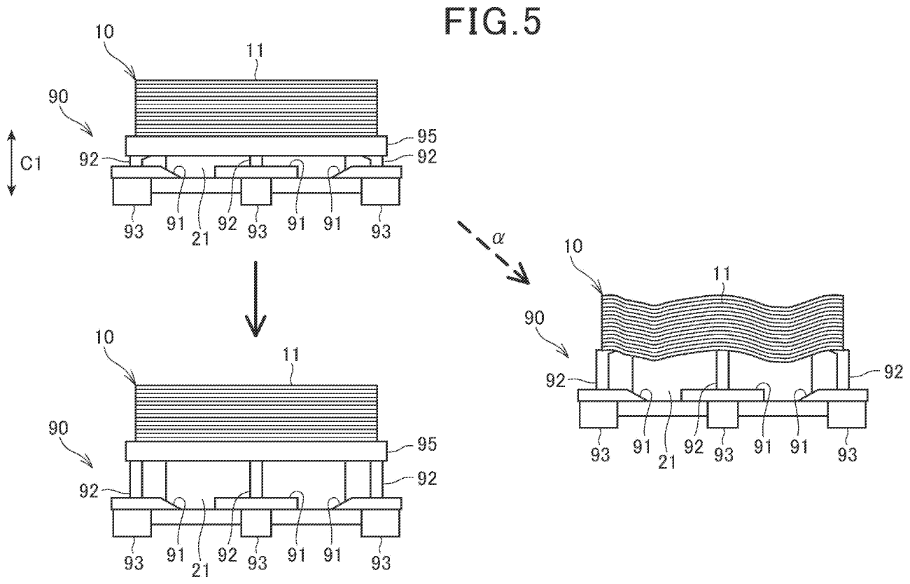

Here, FIG. 5 shows an example of a jig 90 used in the extraction step.

The jig 90 has chucks 91 that hold the winding 21 of the stator 10, movable portions 92 that move in the axial direction C of the stator 10, and placement tables 93 that are placed on the work area. In this configuration, the chucks 91 are provided at predetermined angular intervals in the circumferential direction of the stator 10 and restrict the upward movement or the like of the winding 21. The movable portions 92 are provided at predetermined angular intervals in the circumferential direction of the stator 10, outside the outer circumference of the winding 21.

As shown in FIG. 5, there is a collar 95 interposed between the stator core 11 and the movable portions 92, and each movable portion 92 moves the stator core 11 upward via the collar 95.

The collar 95 is formed in an annular plate shape, has higher rigidity than the stator core 11, and is not deformed by the load F1 acting from each movable portion 92 in the extraction step. Therefore, the pressing force from each movable portion 92 is applied evenly to the stator core 11 via the collar 95, and the stator core 11 is pushed up while being prevented from deformation, so that the winding 21 can be extracted from the stator core 11.

If the collar 95 is not used, loads would concentrate on the position where each movable portion 92 is in contact with the stator core 11, as indicated by the arrow a in FIG. 5, and the concentrated loads may deform the stator core 11. When the stator core 11 is deformed, it becomes difficult to stably push up the stator core 11.

Thus, the collar 95 is arranged between the plurality of movable portions 92 and the stator core 11 to disperse the pressing force from the plurality of movable portions 92 and transmit it to the stator core 11. This enables the stator core 11 to be moved without being deformed and enables the stator core 11 and the winding 21 to be properly separated.

Note that the shape and configuration of each portion of the jig 90, the shape of the collar 95, or the like may be changed as appropriate.

In the stator 10 having this configuration, the adhesive forces in extraction satisfy “adhesives G1, G2<varnish”. Therefore, the winding 21 can be separated from the stator core 11 at either of the position K1 of the adhesive G1 and the position K2 of the adhesive G2 (see FIG. 2).

Since the winding 21 can be separated at either of the positions K1 and K2 shown in FIG. 2, the portion that remains on the winding 21 side is just a portion of the insulating paper 41. In any of a case in which the adhesive forces of the adhesives G1 and G2 have not yet returned to the original adhesive forces after the heating step and a case in which the adhesive forces maintain a state of “adhesives G1, G2<varnish 31”, the adhesive forces in extraction satisfy “adhesive G1, G2<varnish 31”. This allows avoiding a case in which the winding 21 cannot be separated due to the strong adhesive force of the varnish 31, and allows the extraction load F1 to be relatively a small load.

Note that the high temperature T1 is set to a temperature at which the adhesive forces of the adhesives G1 and G2 sufficiently decrease to the extent that the winding 21 can be extracted, and the load F1 is set to a load suitable for separating the adhesives G1 and G2 at either of the positions K1 and K2. In other words, the adhesives G1 and G2 are adjusted or selected so as to have adhesive forces that allow the winding 21 to be extracted at the high temperature T1. Appropriate values need to be set for various parameters such as the set temperature T2, the high temperature T1, the temperature TX, the load F1, and the adhesive forces of the adhesives G1 and G2.

Returning to FIG. 4, after the extraction step, a separation step of step S4A is performed. In the separation step, the winding 21 is removed from the jig 90. This completes the work for separating the stator core 11 and the winding 21.

In this separation work, the adhesive forces of the adhesives G1 and G2 are reduced to extract the winding 21 in the axial direction C1 in this configuration. Here, the slot of the stator core 11 may have a bottleneck shape in which the outlet side (inner circumferential side) in the radial direction is relatively narrow. The bottleneck shape makes it difficult to separate the U-shaped conductor 22 from the outlet side (inner circumferential side). In this configuration, since the winding 21 is extracted in the axial direction C1, it is also advantageous that the conductor 22 can be easily separated even in the bottleneck shape.

As described above, the winding separation method of the present embodiment includes the heating step of heating the stator 10, the cutting step of cutting a predetermined welded portion of the stator 10 and a portion of the winding 21, and the extraction step of extracting the winding 21 from the stator core 11. In addition, the heat-resistant temperature of the insulating paper 41 is lower than the glass transition temperature of the insulating coating that covers the winding 21.

According to this configuration, the heating step heats the electric motor stator 10 to a temperature that is equal to or higher than the heat-resistant temperature of the insulating paper 41 while maintaining the insulating properties of the insulating coating. This allows the extraction step to separate the winding 21 more easily at the position of the insulating paper 41, and allows the heating step to apply heating using energization of the winding 21 or heating with a furnace, improving the degree of freedom in the heating method. Further, the separation of the winding 21 at the position of the insulating paper 41 allows reduction of foreign materials adhering on the side of winding 21. This makes it possible to provide a winding separation method that can be applied to an electric motor stator employed for a vehicle and that allows applying heating using energization of the winding 21. For example, this allows the winding 21 to be recycled as high-grade materials, and allows the stator core 11, that is, the electromagnetic steel plates to be recycled more easily. Therefore, this can provide a winding separation method suitable for recycling the winding 21 and the stator core 11.

Also, the temperatures T2 and T1 corresponding to heating temperatures in the heating step are equal to or higher than the heat-resistant temperature of the insulating paper 41 and lower than the glass transition temperature of the insulating coating. This configuration allows avoiding short circuit or the like of the winding 21 when the winding 21 is heated by the electric heating method, and allows easily separating the winding 21 at the position of the insulating paper 41 in the extraction step.

Also, the heating step causes the winding 21 to be energized to heat up to the heating temperature. Therefore, it can be expected to heat the stator 10 (especially the insulating paper 41) with less energy compared to the case in which a furnace is used, facilitating reduction of carbon dioxide generation.

The stator core 11 is provided with the teeth 11T protruding to inner circumferential side at intervals in the circumferential direction. The adjacent teeth 11T form the slots therebetween in which the insulating paper 41 and the winding 21 are fixed with the varnish 31. Even in a configuration in which the insulating paper 41 and the winding 21 are strongly fixed by the varnish 31, the winding 21 can be easily separated without being affected by variations in the varnish impregnation rate.

Also, in the extraction step, the winding 21 is extracted from the stator core 11 in the axial direction C1. Therefore, even if the stator core 11 has a bottleneck shape in which the slot is narrowed in the radial direction, the winding 21 can be easily separated.

The cutting step cuts the welded portion and the bent portion 22B of the winding 21, located on one side in the axial direction with respect to the stator core 11, which portions both hinder the extraction step. The extraction step extracts the winding 21 from the stator core 11 to the other side in the axial direction. This facilitates the work for separating the winding 21 in the extraction step.

The stator 10 is used in a vehicle electric motor, so the stator 10 is used in severe environments in terms of temperature, vibration, or the like, so that the stator 10 has a complicated structure and the winding or the like is strongly bonded.

Even with such a configuration, the winding 21 can be easily separated.

The above embodiment is just one aspect of implementation of the present invention, and can be modified and applied in any manner without departing from the scope of the present invention.

For example, description has been made on a case in which the adhesives G1 and G2 of the insulating paper 41 are adjusted or selected so that the heat-resistant temperature of the insulating paper 41 is lower than the glass transition temperature of the insulating coating, but the present invention is not limited to this. For example, the insulating paper 41 to be employed may be a foam insulating paper in which a foaming agent is adjusted so that the heat-resistant temperature of the insulating paper 41 is lower than the glass transition temperature of the insulating coating. In short, the type, structure, material, or the like of the insulating paper 41 may be appropriately changed as long as the heat-resistant temperature of the insulating paper 41 is lower than the glass transition temperature of the insulating coating.

In addition, although description has been made on the case in which the present invention is applied to the stator 10 with SC winding specifications, the present invention may be applied to a stator other than the stator with SC winding specifications. For example, some distributed winding stators are impregnated with varnish and have the same structures as shown in FIG. 2. Application of the present invention to such stators facilitates separating the winding 21 without being affected by variations in the varnish impregnation rate. Further, the stator 10 is not limited to a stator for vehicles such as four-wheeled vehicles or a saddle-ride vehicles, and may be a stator for aircraft, ships, and other industries. Moreover, the stator 10 may be a stator for rotating electric machines including electric motors and generators. In other words, the winding separation method of the present invention can be applied to various stators for rotating electric machines.

### Configuration Supported by Above Embodiment

The above embodiment supports the following configurations.

(Configuration 1) A winding separation method of separating a winding from an electric motor stator having insulating paper between a stator core and the winding, the winding being covered with a coating having insulating properties, the winding separation method including: a heating step of heating the electric motor stator; a cutting step of cutting a predetermined welded portion of the electric motor stator and a portion of the winding; and an extraction step of extracting the winding from the stator core, in which a heat-resistant temperature of the insulating paper is lower than a glass transition temperature of the coating.

According to this configuration, the heating step heats the electric motor stator to a temperature that is equal to or higher than the heat-resistant temperature of the insulating paper while maintaining the insulating properties of the insulating coating. This causes the extraction step to separate the winding more easily at the position of the insulating paper. This also allows the heating step to apply heating using energization of the winding or heating with a furnace, resulting in an improved degree of freedom of the heating method. Further, separation of the winding at the position of the insulating paper allows reduction of foreign materials adhering on the side of winding. Accordingly, a winding separation method can be provided that can be applied to an electric motor stator employed for a vehicle, that allows applying heating using energization of the winding, and that is suitable for recycling the winding.

(Configuration 2) The winding separation method according to Configuration 1, in which a heating temperature in the heating step is equal to or higher than the heat-resistant temperature of the insulating paper and lower than the glass transition temperature of the coating.

This configuration allows avoiding short circuit or the like of the winding when the winding is heated by the electric heating method, and allows easily separating the winding at the position of the insulating paper in the extraction step.

(Configuration 3) The winding separation method according to Configuration 2, in which the heating step energizes the winding to heat the winding to the heating temperature.

This configuration allows expecting an effect of heating the stator with less energy in the case in which the electric heating method is employed, compared to a case of using a furnace, resulting in easier reduction in carbon dioxide to be generated.

(Configuration 4) The winding separation method according to any one of Configurations 1 to 3, in which the stator core is provided with teeth protruding to an inner circumferential side at intervals in a circumferential direction, and the insulating paper and the winding are fixed with varnish in a slot formed between the teeth that are adjacent to each other.

This configuration allows easily separating the winding without being affected by variation in the varnish impregnation rate even in a configuration in which the insulating paper and the winding are strongly fixed with the varnish.

(Configuration 5) The winding separation method according to any one of Configurations 1 to 4, in which the cutting step cuts the welded portion and a bent portion of the winding, the bent portion being located on one side in an axial direction with respect to the stator core, the welded portion and the bent portion both hindering the extraction step, and the extraction step extracts the winding from the stator core to another side in the axial direction.

This configuration facilitates work for separating the winding in the extraction step.

(Configuration 6) The winding separation method according to any one of Configurations 1 to 5, in which the electric motor stator is a stator used for a vehicle electric motor.

This configuration allows easily separating the winding from an apparatus that has a complicated structure due to use in severe environments in terms of temperature, vibration, or the like and has a strongly bonded winding or the like.

### REFERENCE SIGNS LIST

10 . . . electric motor stator, 11 . . . stator core, 11A . . . yoke, 11T . . . teeth, 12 . . . coil, 21 . . . winding, 31 . . . varnish, 33, 43 . . . surface material, 41 . . . insulating paper, 42 . . . base material, G1 . . . winding side adhesive, G2 . . . core side adhesive, TO . . . normal temperature (heating temperature, second temperature), T1 . . . temperature in extraction (heating temperature, first temperature), T2 . . . set temperature, C1 . . . axial direction.

What is claimed is:

1. A winding separation method of separating a winding from an electric motor stator having insulating paper between a stator core and the winding,
the winding being covered with a coating having insulating properties, the winding separation method comprising:
a heating step of heating the electric motor stator;
a cutting step of cutting a predetermined welded portion of the electric motor stator and a portion of the winding; and
an extraction step of extracting the winding from the stator core,
characterized in that a heat-resistant temperature of the insulating paper is lower than a glass transition temperature of the coating.

2. The winding separation method according to claim 1, wherein a heating temperature in the heating step is equal to or higher than the heat-resistant temperature of the insulating paper and lower than the glass transition temperature of the coating.

3. The winding separation method according to claim 2, wherein the heating step energizes the winding to heat the winding to the heating temperature.

4. The winding separation method according to claim 1, wherein the stator core is provided with teeth protruding to an inner circumferential side at intervals in a circumferential direction, and the insulating paper and the winding are fixed with varnish in a slot formed between the teeth that are adjacent to each other.

5. The winding separation method according to claim 1, wherein
the cutting step cuts the welded portion and a bent portion of the winding, the bent portion being located on one side in an axial direction with respect to the stator core, the welded portion and the bent portion both hindering the extraction step, and
the extraction step extracts the winding from the stator core to another side in the axial direction.

6. The winding separation method according to claim 1, wherein the electric motor stator is a stator used for a vehicle electric motor.
